(19) United States
(12) Patent Application Publication
(10) Pub. No.: US 2015/0328859 A1
(43) Pub. Date: Nov. 19, 2015

(54) THERMAL PROTECTION SYSTEM AND METHOD OF MANUFACTURING THEREOF

(71) Applicant: The Boeing Company, Huntington Beach, CA (US)

(72) Inventors: Jeffrey D. Britton, Berkeley, MO (US); MaryAnn S. Muench, Huntington Beach, CA (US); Christopher P. Henry, Malibu, CA (US); Tiffany Stewart, Malibu, CA (US)

(21) Appl. No.: 14/707,143

(22) Filed: May 8, 2015

Related U.S. Application Data
(60) Provisional application No. 61/994,568, filed on May 16, 2014.

(51) Int. Cl. B32B 3/04; B32B 9/04; B64C 1/40; B32B 37/14; B32B 37/18; B64G 1/58; B32B 9/00; B32B 7/12

(52) U.S. Cl. CPC B32B 3/04; B32B 9/005; B32B 9/047; B32B 9/046; B32B 7/12; B32B 37/144; B32B 37/18; B64G 1/58; B64C 1/40; B32B 2266/04; B32B 2262/105; B32B 2307/558; B32B 2307/56; B32B 2307/304; B32B 2605/18

(57) ABSTRACT

A thermal protection system is provided. The thermal protection system includes a thermally insulative core structure, at least one layer of impact-resistant material coupled to the thermally insulative core structure, and at least one layer of composite material at least partially encapsulating the thermally insulative core structure and the at least one layer of impact-resistant material.

### CROSS REFERENCE TO RELATED APPLICATIONS

This application claims priority to U.S. Provisional Application No. 61/994,568 filed May 16, 2014, which is hereby incorporated by reference in its entirety.

### BACKGROUND

The field of the present disclosure relates generally to thermal protection systems and, more specifically to, impact-resistant thermal protection systems.

Thermal protection systems are generally implemented in the aerospace industry to thermally shield reusable launch vehicles (RLVs) from high temperatures caused by re-entry into Earth's atmosphere, or on certain aircraft in locations downstream from high-temperature engine exhaust, for example. At least some known thermal protection systems are formed from a series of insulative tiles that facilitate maintaining a temperature of a metallic and/or composite substructure of the vehicle below the thermal protection system. At least some known insulative tiles are formed from a combination of a ceramic matrix composite (CMC) material and ceramic foam material.

Ceramic matrix composites are generally formed from a continuous reinforcing phase (i.e., ceramic and/or carbon fibers) embedded in a ceramic phase (i.e., a matrix material). Ceramic foam is generally formed in a felting process where ceramic fibers are coupled to each other via self-coupling and Van der Waals forces before being sintered together in a firing process. Ceramic materials generally have desirable physical properties for use in aerospace applications such as, but not limited to, high-temperature stability, high thermal-shock resistance, high hardness, high corrosion resistance, and nonmagnetic and nonconductive properties. However, ceramic foam is generally brittle and unable to withstand substantial impacts from foreign objects, which may compromise the thermally insulative properties of the thermal protection system.

### BRIEF DESCRIPTION

In one aspect, a thermal protection system is provided. The thermal protection system includes a thermally insulative core structure, at least one layer of impact-resistant material coupled to the thermally insulative core structure, and at least one layer of composite material at least partially encapsulating the thermally insulative core structure and the at least one layer of impact-resistant material.

In another aspect, a method of manufacturing a thermal protection system is provided. The method includes positioning at least one layer of composite material in an internal cavity of a shell mold assembly, positioning at least one layer of impact-resistant material over the at least one layer of composite material, positioning a thermally insulative core structure over the at least one layer of impact-resistant material, and applying at least one of heat or pressure to the shell mold assembly such that the at least one layer of composite material, the at least one layer of impact-resistant material, and the thermally insulative core structure form a substantially unitary structure.

### BRIEF DESCRIPTION OF THE DRAWINGS

FIG. 1 is a flow diagram of an exemplary aircraft production and service method.

FIG. 2 is a block diagram of an exemplary aircraft.

FIG. 3 is a schematic illustration of an exemplary thermal protection system.

FIG. 4 is a schematic cross-sectional illustration of an exemplary thermally insulative tile that may be used in the thermal protection system shown in FIG. 3.

FIG. 5 is a schematic cross-sectional illustration of an alternative thermally insulative tile that may be used in the thermal protection system shown in FIG. 3.

FIG. 6 is a schematic cross-sectional illustration of another alternative thermally insulative tile that may be used in the thermal protection system shown in FIG. 3.

FIG. 7 is a schematic cross-sectional illustration of another alternative thermally insulative tile that may be used in the thermal protection system shown in FIG. 3.

FIG. 8 is a schematic flow diagram illustrating an exemplary sequence of process steps of manufacturing the thermally insulative tile shown in FIG. 4.

### DETAILED DESCRIPTION

The implementations described herein relate to thermal protection systems and related methods of manufacture. In the exemplary implementation, the thermal protection system includes a series of thermally insulative tiles that include a variety of design features that enable the thermally insulative tiles to better withstand impacts from foreign objects. Specifically, the thermally insulative tile includes at least a thermally insulative core structure, a layer of composite material, and a layer of impact-resistant material positioned therebetween. The impact-resistant material is formed from either a durable material that deflects impacting energy from foreign objects, or a compressible material that absorbs impacting energy from foreign objects. Moreover, in some implementations, the compressible material and/or the composite material are formed from a knit fabric material that facilitates enhancing the impact-resistance properties of the thermally insulative tile. As such, the thermal protection system described herein includes components that facilitate shielding the thermally insulative structure, and that facilitate improving the service life of thermal protection system.

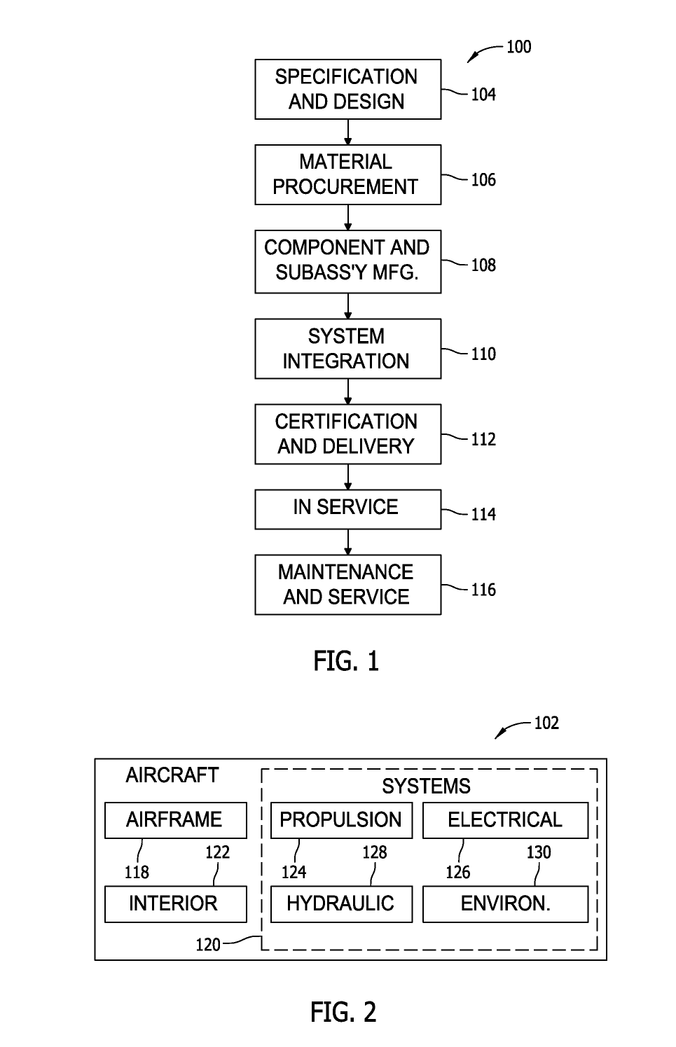

Referring to the drawings, implementations of the disclosure may be described in the context of an aircraft manufacturing and service method 100 (shown in FIG. 1) and via an aircraft 102 (shown in FIG. 2). During pre-production, including specification and design 104 data of aircraft 102 may be used during the manufacturing process and other materials associated with the airframe may be procured 106. During production, component and subassembly manufacturing 108 and system integration 110 of aircraft 102 occurs, prior to aircraft 102 entering its certification and delivery process 112. Upon successful satisfaction and completion of airframe certification, aircraft 102 may be placed in service 114. While in service by a customer, aircraft 102 is scheduled for periodic, routine, and scheduled maintenance and service 116, including any modification, reconfiguration, and/or refurbishment, for example. In alternative implementations, manufacturing and service method 100 may be implemented via vehicles other than an aircraft.

Each portion and process associated with aircraft manufacturing and/or service 100 may be performed or completed by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 2, aircraft 102 produced via method 100 may include an airframe 118 having a plurality of systems 120 and an interior 122. Examples of high-level systems 120 include one or more of a propulsion system 124, an electrical system 126, a hydraulic system 128, and/or an environmental system 130. Any number of other systems may be included.

Apparatus and methods embodied herein may be employed during any one or more of the stages of method 100. For example, components or subassemblies corresponding to component production process 108 may be fabricated or manufactured in a manner similar to components or subassemblies produced while aircraft 102 is in service. Also, one or more apparatus implementations, method implementations, or a combination thereof may be utilized during the production stages 108 and 110, for example, by substantially expediting assembly of, and/or reducing the cost of assembly of aircraft 102. Similarly, one or more of apparatus implementations, method implementations, or a combination thereof may be utilized while aircraft 102 is being serviced or maintained, for example, during scheduled maintenance and service 116.

As used herein, the term “aircraft” may include, but is not limited to only including, airplanes, unmanned aerial vehicles (UAVs), gliders, helicopters, and/or any other object that travels through airspace. Further, in an alternative implementation, the aircraft manufacturing and service method described herein may be used in any manufacturing and/or service operation.

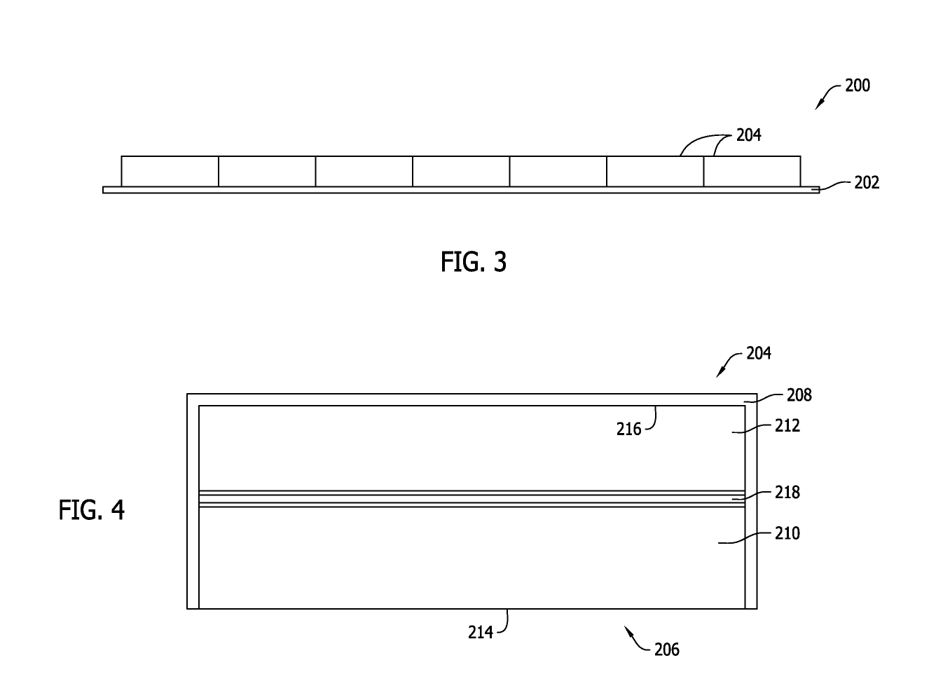

FIG. 3 is a schematic illustration of an exemplary thermal protection system (TPS) 200. In the exemplary implementation, TPS 200 is coupled to a substructure 202 of aircraft 102 (shown in FIG. 2). Specifically, TPS 200 includes a series of thermally insulative tiles 204 that are each coupled to substructure 202. Thermally insulative tiles 204 extend along substructure 202 to form a substantially continuous barrier (not shown) that facilitates shielding substructure 202 from thermal stressors encountered during operation of aircraft 102.

FIG. 4 is a schematic cross-sectional illustration of thermally insulative tile 204. In the exemplary implementation, thermally insulative tile 204 includes a plurality of internal components 206 and at least one layer 208 of composite material at least partially encapsulating internal components 206. More specifically, internal components 206 include a thermally insulative core structure 210 and at least one layer 212 of impact-resistant material coupled to thermally insulative core structure 210 such that layer 208 of composite material at least partially encapsulates thermally insulative core structure 210 and layer 212 of impact-resistant material. For example, layer 208 of composite material extends about thermally insulative core structure 210 and layer 212 of impact-resistant material such that only a first surface 214 of thermally insulative core structure 210 remains exposed. In an alternative implementation, layer 208 of composite material either fully encapsulates thermally insulative core structure 210 and layer 212 of impact-resistant material, or is only coupled to an outermost surface 216 of internal components 206.

Thermally insulative core structure 210 may be fabricated from any thermally insulative material that enables thermally insulative tile 204 to function as described herein. An exemplary thermally insulative material includes, but is not limited to, a ceramic oxide material. Moreover, in one implementation, thermally insulative core structure 210 is formed from ceramic fibers that have been felted and sintered resulting in a substantially foam-like core structure. As such, forming thermally insulative core structure 210 from a ceramic foam material enables thermally insulative core structure 210 to have a density defined within a range between about 14 pounds per cubic foot and about 18 pounds per cubic foot.

The composite material used to form layer 208 may be fabricated from any material that enables thermally insulative tile 204 to function as described herein. For example, the composite material generally includes reinforcement material at least partially impregnated with a matrix material. The reinforcement material is either a woven material or a knit material each formed from ceramic fibers (not shown). The ceramic fibers are formed from a combination of aluminum oxide (Al₂O₃) defined within a range between about 50 percent and 75 percent by weight of the combination, and silicon dioxide (SiO₂) defined within a range between about 25 percent and 50 percent by weight of the combination.

Exemplary woven materials include, but are not limited to, Nextel® series N312, N610, and/or N720 woven fabrics (“Nextel” is a registered trademark of 3M Company of St. Paul, Minn.). An exemplary knit material includes, but is not limited to, ceramic oxide material that may be knitted in any pattern that enables layer 208 of composite material to function as described herein. The ceramic fibers may be knit in a jersey pattern, a bird's eye pattern, an interlock pattern, and/or a hybrid pattern, for example. In an alternative implementation, the reinforcement material may be either a woven material or a knit material each formed from carbon fibers (not shown). The type of reinforcement material is selected as a function of projected operating temperatures of TPS 200 (shown in FIG. 3).

Exemplary matrix materials of layer 208 include ceramic materials such as, but not limited to, alumina, silica, and/or an alumina-silica combination such as Ceramabond® C677 (“Ceramabond” is a registered trademark of Texas Cement Products, Inc. of Houston, Tex.). In one implementation, when Ceramabond® C677 is utilized as the matrix material in layer 208 of composite material, layer 212 of impact-resistant material may be omitted from thermally insulative tile 204 such that layer 208 of composite material is coupled directly to thermally insulative core structure 210. As such, the composite material reinforced with Ceramabond® C677 facilitates shielding thermally insulative core structure 210 from impacting energy of foreign objects (not shown), for example.

In some implementations, at least one layer 218 of adhesive is positioned between thermally insulative core structure 210 and layer 212 of impact-resistant material. The adhesive is any suitable adhesive compatible with the material of thermally insulative core structure 210 and/or the impact-resistant material. Moreover, in one implementation, the adhesive is capable of withstanding temperatures over 1650° F. (899° C.). Alternatively, layer 218 of adhesive is omitted from thermally insulative tile 204, and layer 208 of composite material facilitates ensuring thermally insulative core structure 210 and layer 212 of impact-resistant material remain coupled together.

In the exemplary implementation, thermally insulative tile 204 is oriented relative to substructure 202 (shown in FIG. 3) such that thermally insulative core structure 210 is positioned between substructure 202 and layer 212 of impact-resistant material. As such, layer 212 facilitates shielding thermally insulative core structure 210 from impacting energy of foreign objects (not shown), for example. The impact-resistant material may be any material that enables thermally insulative tile 204 to function as described herein. For example, the impact-resistant material of layer 212 includes at least one layer of durable material that deflects impacting energy from foreign objects, and/or at least one layer of compressible material that absorbs impacting energy from foreign objects. Exemplary durable materials include, but are not limited to, a sintered reaction-bonded silicon nitride material, and a transformation toughened zirconia material.

An exemplary compressible material includes, but is not limited to, a knit material formed from ceramic fibers (not shown). The ceramic fibers may be formed from a ceramic oxide material similar to the material used to form the reinforcement material of layer 208, and may be knitted in any pattern that enables layer 212 of impact-resistant material to function as described herein. The ceramic fibers may be knit in a jersey pattern, a bird's eye pattern, an interlock pattern, and/or a hybrid pattern, for example. As such, physical properties of layer 212 of impact-resistant material are selected as a function of the knitting pattern of the ceramic fibers in the compressible impact-resistant material. Moreover, in some implementations, the knit compressible impact-resistant material is inlaid and/or floated with secondary fibers (not shown). The secondary fibers facilitate enhancing physical properties of layer 212 such as, but not limited to, increased fiber volume fraction, stiffness, strength, erosion and impact toughness, and/or dielectric property control. For example, layer 212 may be formed from primary fibers including Nextel® 312 and from secondary fibers including Nextel® 720

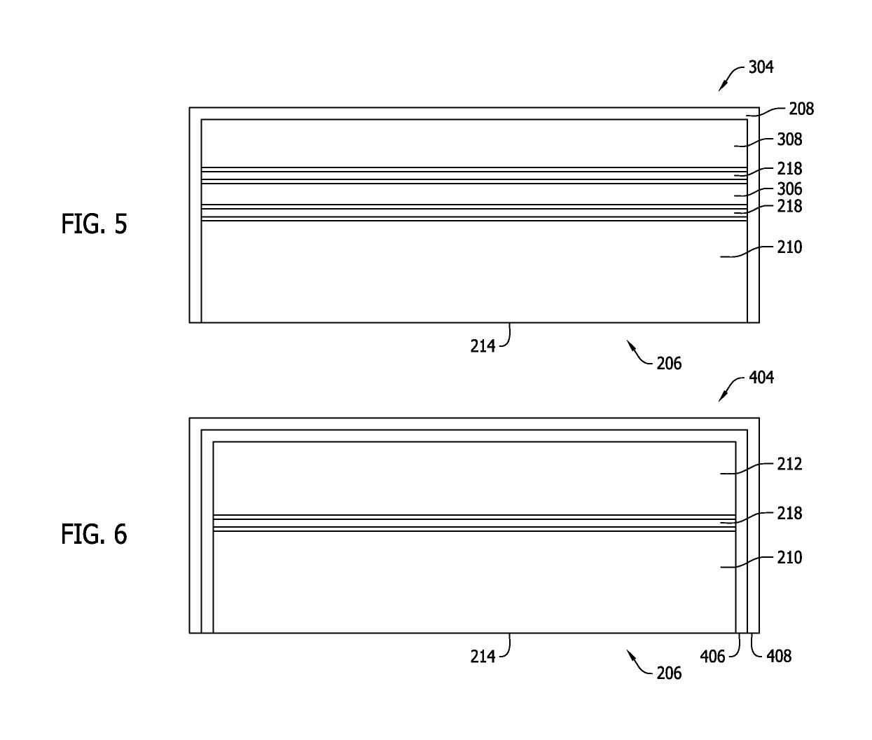

FIG. 5 is a schematic cross-sectional illustration of an alternative thermally insulative tile 304. In the exemplary implementation, thermally insulative tile 304 includes thermally insulative core structure 210, a layer 306 of compressible material coupled to thermally insulative core structure 210, and a layer 308 of durable material coupled to layer 218 of compressible material. Layer 308 defines outermost surface 216 of internal components 206 to facilitate deflecting impacting energy before it can reach less durable portions of internal components 206. Moreover, defining layer 308 as outermost surface 216 surface deformations to thermally insulative tile 304 such that substantially smooth airflow across thermally insulative tile 304 is substantially maintained.

FIG. 6 is a schematic cross-sectional illustration of another alternative thermally insulative tile 404. In the exemplary implementation, thermally insulative tile 404 includes thermally insulative core structure 210, layer 212 of impact-resistant material, and a first layer 406 and a second layer 408 of composite material coupled to thermally insulative core structure 210 and layer 212 of impact-resistant material. Specifically, first layer 406 in a first orientation at least partially encapsulates thermally insulative core structure 210 and layer 212 of impact-resistant material, and second layer 408 in a second orientation is coupled to first layer 406. As such, having first and second layers 406 and 408 in different orientations facilitates improving the isotropic mechanical properties of thermally insulative tile 404, and facilitates mitigating stresses caused by differing directions of thermal expansion.

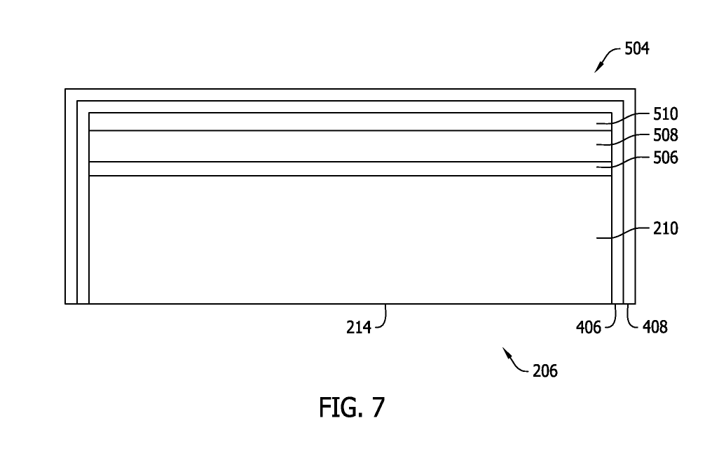

FIG. 7 is a schematic cross-sectional illustration of another alternative thermally insulative tile 504. In the exemplary implementation, thermally insulative tile 504 includes thermally insulative core structure 210, a first layer 506 of woven material, a layer 508 of compressible impact-resistant material, a second layer 510 of woven material, and first and second layer 406 and 408 of composite material. Specifically, layer 508 of compressible impact-resistant material is positioned between first and second layers 506 and 510 of woven material, which enables layers 506 and 510 to elastically deform when impinged by impacting energy. In an alternative implementation, layer 506 and 510 may be fabricated from a knit material.

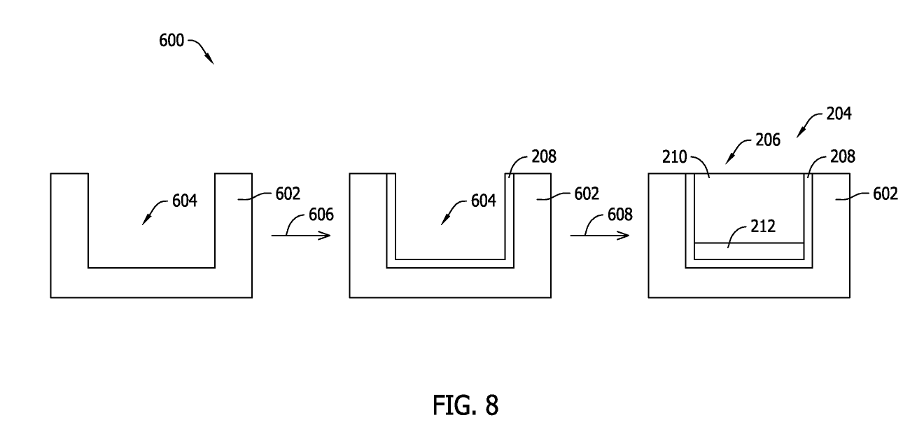

FIG. 8 is a schematic flow diagram illustrating an exemplary sequence 600 of process steps of manufacturing thermally insulative tile 204. In the exemplary implementation, thermally insulative tile 204 is manufactured in a shell mold assembly 602 that includes an internal cavity 604 having a shape that substantially matches a final desired shape of thermally insulative tile 204. As such, each internal component 206 of thermally insulative tile 204 is positioned in shell mold assembly 602, and heat and/or pressure are applied in a series of process steps to facilitate manufacturing thermally insulative tile 204.

For example, in the exemplary implementation, sequence 600 includes first and second process steps 606 and 608. In each process step of sequence 600, internal components 206 of thermally insulative tile 204 are positioned within shell mold assembly 602 and cured at an elevated temperature of about 2500° F. and/or pressure to form a substantially unitary structure. Specifically, first process step 606 includes positioning layer 208 of composite material in shell mold assembly 602, and impregnating reinforcement material of layer 208 with matrix material. Shell mold assembly 602 is then cured such that layer 208 substantially conforms to a shape of internal cavity 604. Second process step 608 includes positioning layer 212 of impact-resistant material over an inner surface of layer 208 of composite material, and positioning thermally insulative core structure 210 over layer 212 of impact-resistant material. Shell mold assembly 602 is then cured to form thermally insulative tile 204. In an alternative implementation, thermally insulative tiles 304, 404, and 504 may be manufactured in a similar series of process steps.

The implementations described herein relate to an impact-resistant thermal protection system. The thermal protection system is formed from a series of thermally insulative tiles coupled to a substructure of an aerospace vehicle. The thermally insulative tiles include a variety of design features such as, but not limited to, a layer of impact-resistant material, more durable matrix material, and/or layers of ceramic oxide knit fabric material that enable the thermally insulative tiles to better withstand impacts from foreign objects. As such, the systems and methods described herein facilitate improving the service life of, while substantially maintaining the thermally insulative properties of known thermal protection systems.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A thermal protection system comprising:
a thermally insulative core structure;
at least one layer of impact-resistant material coupled to said thermally insulative core structure; and
at least one layer of composite material at least partially encapsulating said thermally insulative core structure and said at least one layer of impact-resistant material.

2. The system in accordance with claim 1, wherein said thermally insulative core structure comprises a ceramic foam material.

3. The system in accordance with claim 1, wherein said at least one layer of impact-resistant material comprises at least one layer of compressible material configured to absorb impacting energy from foreign objects.

4. The system in accordance with claim 3, wherein said at least one layer of compressible material comprises a knit material formed from ceramic fibers.

5. The system in accordance with claim 1, wherein said at least one layer of impact-resistant material comprises at least one layer of durable material configured to deflect impacting energy from foreign objects.

6. The system in accordance with claim 5, wherein said at least one layer of durable material is fabricated from at least one of a sintered reaction-bonded silicon nitride material or a transformation toughened zirconia material.

7. The system in accordance with claim 1 further comprising at least one layer of adhesive positioned between said thermally insulative core structure and said at least one layer of impact-resistant material.

8. The system in accordance with claim 1, wherein said at least one layer of composite material comprises at least one layer of ceramic matrix composite material.

9. The system in accordance with claim 1, wherein said at least one layer of composite material comprises a first layer of composite material in a first orientation at least partially encapsulating said thermally insulative core structure and said at least one layer of impact-resistant material, and a second layer of composite material in a second orientation coupled to said first layer of composite material.

10. The system in accordance with claim 1 further comprising:
a first layer of woven material positioned between said at least one layer of impact-resistant material and said at least one layer of composite material; and
a second layer of woven material positioned between said at least one layer of impact-resistant material and said thermally insulative core structure.

11. A method of manufacturing a thermal protection system, said method comprising:
positioning at least one layer of composite material in an internal cavity of a shell mold assembly;
positioning at least one layer of impact-resistant material over the at least one layer of composite material;
positioning a thermally insulative core structure over the at least one layer of impact-resistant material; and
applying at least one of heat or pressure to the shell mold assembly such that the at least one layer of composite material, the at least one layer of impact-resistant material, and the thermally insulative core structure form a substantially unitary structure.

12. The method in accordance with claim 11 further comprising forming the thermally insulative core structure from a ceramic foam material.

13. The method in accordance with claim 11, wherein positioning at least one layer of impact-resistant material comprises positioning at least one layer of compressible material over the at least one layer of composite material, the compressible material configured to absorb impacting energy from foreign objects.

14. The method in accordance with claim 13 further comprising forming the at least one layer of compressible material from a knit material including ceramic fibers.

15. The method in accordance with claim 11, wherein positioning at least one layer of impact-resistant material comprises positioning at least one layer of durable material over the at least one layer of composite material, the durable material configured to deflect impacting energy from foreign objects.

16. The method in accordance with claim 15 further comprising fabricating the at least one layer of durable material from at least one of a sintered reaction-bonded silicon nitride material or a transformation toughened zirconia material.

17. The method in accordance with claim 11 further comprising positioning at least one layer of adhesive between the thermally insulative core structure and the at least one layer of impact-resistant material.

18. The method in accordance with claim 11 further comprising forming the at least one layer of composite material from a ceramic matrix composite material.

19. The method in accordance with claim 11, wherein positioning at least one layer of composite material comprises:
positioning a first layer of composite material in a first orientation in the internal cavity; and
positioning a second layer of composite material in a second orientation over the first layer of composite material.

20. The method in accordance with claim 11 further comprising:
positioning a first layer of woven material between the at least one layer of impact-resistant material and the at least one layer of composite material; and
positioning a second layer of woven material between the at least one layer of impact-resistant material and the thermally insulative core structure.
